(19) United States
(12) Patent Application Publication
(10) Pub. No.: US 2007/0183363 A1
(43) Pub. Date: Aug. 9, 2007

(54) Method for ipv4 mobility from ipv6 networks

(75) Inventor: Anders Liden, Skelleftea (SE)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(73) Assignee: INTERACTIVE PEOPLE UNPLUGGED AB, Stockholm (SE)

(21) Appl. No.: 10/597,130

(22) PCT Filed: Jan. 17, 2005
(86) PCT No.: PCT/SE05/00039

§ 371 Date: Jul. 12, 2006

Related U.S. Application Data
(60) Provisional application No. 60/536,491, filed on Jan. 15, 2004.

(51) Int. Cl. H04Q 7/00

(52) U.S. Cl. 370/331

(57) ABSTRACT

A method for allowing a Mobile IPv4 Mobile Node (2) to communicate from an IPv6 visited network (5), and across IPv6 networks, back to a Mobile IPv4 Home Agent (1), in a Mobile IPv4 Network (4), comprising a Mobile Node supporting Mobile IPv4 registration procedures including IvPv6 addressing details to support MN-HA communication; a Home Agent supporting connectivity to both IPv4 and IPv6 networks to facilitate remote access; tunneling of IPv4 traffic over IPv6 networks from the Mobile Node; and, tunneling of Mobile IPv4 traffic over IPv6 networks from the Home Agent.

### FIELD OF THE INVENTION

The present invention relates to mobile data communication in general. More specifically, the present invention describes a method for IPv4 mobility from IPv6 networks using Mobile IPv4 signaling sent over IPv6, together with a new Mobile IPv4 extension.

### BACKGROUND OF THE INVENTION

The following definitions are introduced for the purpose of clarity.

FA Foreign Agent: The primary responsibility of an FA is to act as a tunnel agent which establishes a tunnel to a HA on behalf of a Mobile Node in mobile IPv4.

HA Home Agent: The primary responsibility of the HA is to act as a tunnel agent which terminates the Mobile IPv4 tunnel, and which encapsulates datagrams to be sent to the Mobile Node in Mobile IPv4.

IETF, Internet Engineering Task Force: The IETF is the standardization organization for the Internet community.

IPv4, Internet Protocol version 4: IPv4 is a network layer protocol according to the ISO protocol layering. IPv4 is the major end-to-end protocol between Mobile and Fixed End-Systems for Data Communications.

IPv6,lnternet Protocol version 6: IPv6 is a network layer protocol according to the ISO protocol layering. IPv6 is the next generation end-to-end protocol between Mobile and Fixed End-Systems for Data Communications.

MIPv4, Mobile IPv4: MIPv4 is an IPv4 mobility standard being defined by the IETF with the purpose to make IPv4 networks mobility aware, i.e. providing IPv4 entities knowledge on where a Mobile Node is attached to the network. The standard includes the definition of a Foreign Agent and a Home Agent.

MN Mobile Node: The MN comprises both the Terminal Equipment (TE) and the Mobile Termination (MT). In the context of this patent application the Mobile Node is always using MIPv4.

NAT-PT, Network Address Translation — Protocol Translation: A translation point between an IPv6 and IPv4 network allowing native IPv6 hosts and applications to communicate with native IPv4 hosts and applications, and vice-versa.

Public Network: As used in this document this refers to the network to that the Home Agent connects to, over which the remotely connecting MN connects. In this document, this may be an IPv4 and/or IPv6 network.

RFC, Request For Comment: The collective name of standard documents produced within the IETF. Each standard document starts with RFC and a number, e.g. RFC3519 is the standard for Mobile IPv4 NAT traversal.

Mobile IPv4 is defining a Home Agent as the anchor point with which the Mobile Node always has a relationship, and a Foreign Agent, which acts as the local tunnel-endpoint at the access network where the Mobile Node is visiting. While moving from one IPv4 sub network to another, the Mobile Node point of attachment (FA) may change. At each point of attachment, mobile IPv4 either requires the availability of a standalone Foreign Agent or the usage of a co-located care-of address in the Mobile Node itself in the case that no Foreign Agent is available.

The present invention aims at providing a method for IPv4 mobility from IPv6 networks using Mobile IPv4 signalling together with a new Mobile IPv4 extension.

### SUMMARY OF INVENTION

The following invention describes a method for IPv4 mobility from IPv6 networks, using Mobile IPv4 signaling sent over IPv6, together with a new Mobile IPv4 extension.

### BRIEF DESCRIPTION OF THE DRAWINGS

The foregoing and other objects, features, and advantages of the invention will be apparent from the following description of preferred example embodiments as well as illustrated in the accompanying drawings in which reference characters refer to the same parts throughout.

FIG. 1 is a flow chart diagram showing a Mobile Node registering from an IPv6 network or returning to the home network.

FIG. 2 is a flow chart diagram showing a Mobile Node registering from an IPv6 network configured with a NAT-PT gateway or returning to the home network.

### DETAILED DESCRIPTION OF THE DRAWINGS

In the following description, for the purposes of explanation and not limitation, specific details are set forth, such as particular embodiments, circuits, signal formats, techniques, etc. in order to provide a thorough understanding of the present invention. Although specific protocols are referred to for the purpose of facilitation the description, the present invention is not necessarily limited to such specific protocols. However, it will be apparent to one skilled in the art that the present invention may be practiced in other embodiments that depart from these specific details. In other instances, detail description of well-known methods, devices, and circuits are omitted so as not to obscure the description of the present invention under unnecessary detail.

The present invention provides a method for IPv4 mobility from IPv6 networks, using Mobile IPv4 signaling messages that are sent over IPv6. In this method a new Mobile IPv4 extension is used to hold the IPv6 care-of address of the Mobile Node in the Registration Request.

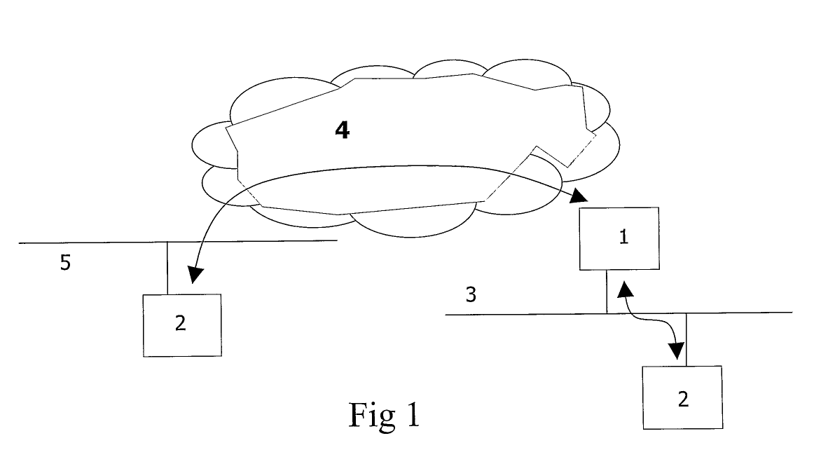

FIG. 1 illustrates a Mobile Node (2) registering in a visited IPv6 network (5), in co-located mode. The Mobile Node will send a registration request to the Home Agent (1) over IPv6 (MIPv4 message encapsulated in IPv6 packet) with an extension containing the IPv6 care-of address for the Mobile Node. This is the IPv6 address that the Mobile Node has received on the IPv6 connection. Upon receiving the registration request, the Home Agent (1) will use the IPv6 address included in the extension as the end-point of the IPv4 over IPv6 tunnel that is set up from the Home Agent (1) to the Mobile Node. (2) In this figure the Home Agent (1) has a connection to the IPv6 network.

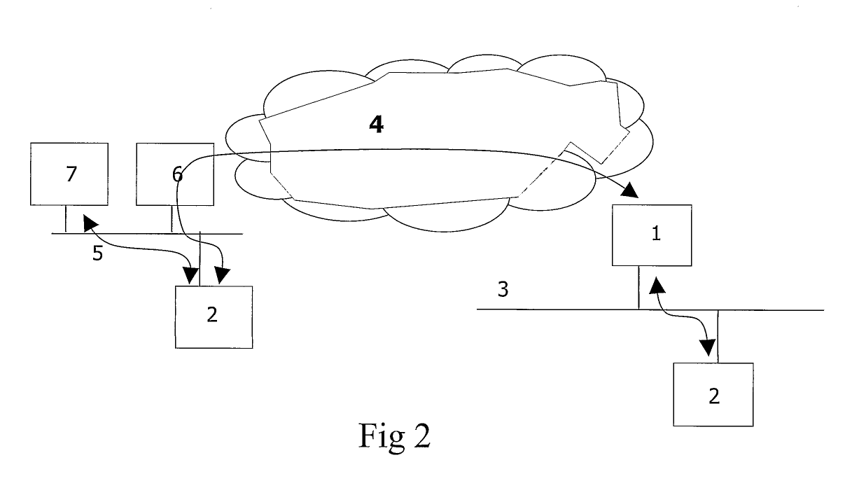

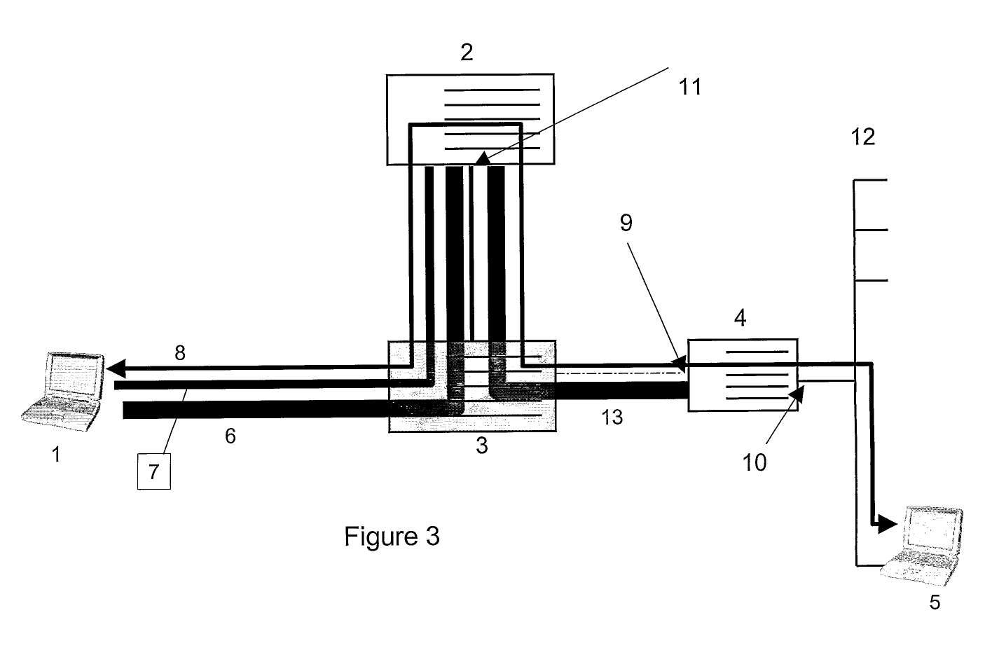

FIG. 2 illustrates a Mobile Node (2) registering in a visited IPv6 network (5), that is configured with a NAT-PT gateway (6), in co-located mode. The Mobile Node (2) will look up the IPv6 address of the Home Agent (1) from the DNSv6 server (7). When the IPv6 address is received from the DNSv6 server, the Mobile Node will send a registration request to the Home Agent (1) over IPv6 with an extension containing the IPv6 care-of address for the Mobile Node. The packet containing the registration request will be translated from IPv6 to IPv4 in the NAT-PT gateway (6) and sent over IPv4 (4) to the Home Agent (1). Upon receiving the registration request, the Home Agent will use the source address of the registration request as the end-point of the IPv4 UDP tunnel. In this figure the Home Agent (1) has a connection to the IPv4 network.

### DESCRIPTION OF THE INVENTION

The proposed method to solve the problem of running IPv4 applications when attached to IPv6 access networks extends Mobile IPv4 with the possibility to register over IPv6. There exists a few pre-requisites in order to use Mobile IPv4 over IPv6:
The Home Agent must be globally reachable through an IPv6 address;
The Mobile Node needs to know the IPv6 address of the Home Agent.

A Mobile Node that is attached to an IPv6 access network, can configure itself with an IPv6 address using stateless or stateful address auto-configuration, or possibly DHCPv6. When the Mobile Node notices that it is attached to an IPv6 network, it sends a Mobile IPv4 Registration Request in an IPv6 UDP datagram to the IPv6 address of the Home Agent. The Home Agent sets up IPv6 tunnel towards the Mobile Node and sends a Registration Reply back to the Mobile Node. For this to work, a new Mobile IPv4 extension needs to be defined that can store the IPv6Care-of address of the Mobile Node as the care-of address field in the Registration Request is too small. This extension is attached to the Registration Request that is sent to the Home Agent.

This solution will allow the mobile user to run IPv4 applications while attached to an IPv6 access network. It even allows the Mobile IPv4 user to seamlessly roam between IPv4 and IPv6 access networks, which means that a mobile user that is running IPv4 applications does not need to be aware of the Internet protocol used in the access network.

The Mobile Node employed in this solution is also a Mobile IPv4 Mobile Node, however, it too supports connectivity to IPv6 networks, where necessary, in order to be able to tunnel Mobile IPv4 traffic back to the Home Agent.

In this patent application, two scenarios are considered:

Where the Mobile Node is connecting over an IPv6 network, the whole way back to its Home Agent.

Where the Mobile Node is connecting over an IPv6 network, but protocol translation between IPv6 and IPv4 takes place between the Mobile Node and the Home Agent, and the connecting on the public network side of the Home Agent is to an IPv4 network.

Considering each of these cases in more details:

Remote Connection from IPv6 Visited Network, with IPv6 all the way back to the HA

In this case, the Mobile Node is visiting an IPv6 network remote from the Home Network. The connectivity from the Mobile Node the whole way back to the Home Agent is over IPv6, and the Home Agent is required to have IPv6 connectivity also. The following events occur:
The Mobile Node connects on the IPv6 network, and acquires an IPv6 address on this network.
The Mobile Node will then proceed to register co-located from the visited IPv6 network. As described above, the Mobile Node has acquired an IPv6 address in the visited IPv6 network. The Mobile Node sends a Mobile IPv4 registration request to its Home Agent over IPv6 with a MIPv4 extension containing the IPv6 care-of address of the Mobile Node.
The Mobile IPv4 registration request will be sent, over the IPv6 network, back to the Home Agent. The care-of address field in the registration request is set to zero.
When the Home Agent receives the registration request it will use the IPv6 address in the IPv6 care-of address extension as the tunnel end-point address when setting up IPv4 over IPv6 tunneling to the Mobile Node.
How the IPv4 over IPv6 tunneling is set up is outside the scope of this patent application. When tunneling has been set up, the Home Agent will send back a registration reply to the Mobile Node over IPv6.
At this point IPv4 traffic can flow between the Mobile Node and the Home Agent.
   Remote Connection from IPv6 Visited Network, with IPv4 Network Connection to HA

In this case, the Mobile Node connects again from an IPv6 visited network, however, in this case the connectivity back to the Home Agent is not IPv6 all the way. The Home Agent connects, on its public network side to an IPv4 network. In this case, tunnel termination of IPv4 over IPv6 traffic is not required to be carried out at the Home Agent. In this scenario, the following events occur:
The Home Agent is configured with an IPv4 address.
The Mobile Node connects on the IPv6 network, and acquires an IPv6 address on this network. How this is done is out of the scope of this patent application.
The Mobile Node proceeds to register co-located from the visited IPv6 network. The visited IPv6 is configured with a NAT-PT gateway.
As the HA is not connected to the IPv6 network, a DNSv6 lookup is required to determine the relevant IPv6 address to use from the visited network, when communicating with the HA. Before the Mobile Node sends a registration request, it will first have to do a DNS lookup from the local DNSv6 server for the IPv6 address of the Home Agent.
The returned IPv6 address will contain the IPv4 address of the Home Agent as described in the NAT-PT RFC 2766. This IPv4 address will be included in the registration request. The care-of address field in the registration request is set to zero.
The Mobile Node will then send a Mobile IPv4 registration request to the IPv6 address retrieved from the DNS server, together with an extension containing the IPv6 care-of address of the Mobile Node, as acquired in the visited network.
The packet containing the registration request will be translated from IPv6 to IPv4 in the NAT-PT gateway, and sent to the IPv4 address of the Home Agent.
Then the Home Agent will authenticate the Mobile Node and as the care-of address field is set to zero in the registration request, the Home Agent will set up UDP tunneling to the source IPv4 address in the registration request, as defined in the NAT traversal RFC 3519.
When UDP tunneling has been set up, the Home Agent will send back a registration reply to the source IPv4 address in the registration request.
The packet containing the registration reply will be translated from IPv4 to IPv6 in the NAT-PT gateway and sent to the IPv6 address of the Mobile Node.
If a Mobile Node moves from an IPv6 network to its home IPv4 network it will de-register from the Home Agent.
Upon receiving a de-registration request the Home Agent will remove the binding entry for the home address of the Mobile Node and stop tunneling to the Mobile Node.

1. A method for allowing a Mobile IPv4 Mobile Node to communicate from an IPv6 visited network, and across IPv6 networks, back to a Mobile IPv4 Home Agent, in a Mobile IPv4 Network, comprising:
a Mobile Node supporting Mobile IPv4 registration procedures including IPv6 addressing details to support MN-HA communication;
a Home Agent supporting connectivity to both IPv4 and IPv6 networks to facilitate remote access;
tunneling of IPv4 traffic over IPv6 networks from the Mobile Node;
tunneling of Mobile IPv4 traffic over IPv6 networks from the Home Agent.

2. The method of claim 1, wherein the Mobile Node acquires an IPv6 address in the visited network.

3. The method of claim 2 wherein the Mobile Node sends a MIPv4 Registration Request over IPv6 using the acquired IPv6 address as source address, and the Home Agent IPv6 address as destination address.

4. The method of claim 2, wherein the Mobile Node includes the acquired IPv6 address as an IPv6 care-of address extension in the Mobile IPv4 Registration Request.

5. The method of claim 1, wherein the Home Agent extracts the IPv6 care-of address from the Registration Request extension and uses it as the tunnel endpoint for the IPv4 in IPv6 tunnel back to the Mobile Node.

6. The method of claim 1, wherein the Mobile Node tunnels IPv4 packets in IPv6 headers, destined for the Home Agent.

7. The method of claim 1, wherein the Mobile Node de-capsulates IPv6 tunneled IPv4 packets from the Home Agent.

8. The method of claim 1, wherein the Home Agent accepts Mobile IPv4 Registration Requests arriving on an IPv6 network.

9. The method claim 1, wherein the Home Agent tunnels IPv4 packets in IPv6 headers, destined for the Mobile Node.

10. The method of claim 1, wherein the Home Agent de-capsulates IPv6 tunneled IPv4 packets from the Mobile Node.

11. The method of claim 1, wherein the Home Agent employs UDP tunneling from the HA to the MN in accordance with RFC 3519.
